(19) United States
(12) Patent Application Publication
(10) Pub. No.: US 2025/0291336 A1
(43) Pub. Date: Sep. 18, 2025

(54) COMPUTER-IMPLEMENTED METHOD, APPARATUS FOR MANAGING PRODUCTION OF ONE OR MORE PRODUCTS, AND COMPUTER-PROGRAM PRODUCT

(71) Applicant: BOE Technology Group Co., Ltd., Beijing (CN)

(72) Inventors: Jinxiao Wen, Beijing (CN); Xibo Zhou, Beijing (CN); Xiaogang Liu, Beijing (CN); Xingliang Wang, Beijing (CN); Dong Zhang, Beijing (CN); Hui Zeng, Beijing (CN); Zhengbao Dai, Beijing (CN); Peiyu Yu, Beijing (CN)

(73) Assignee: BOE Technology Group Co., Ltd., Beijing (CN)

(21) Appl. No.: 18/861,397

(22) PCT Filed: Dec. 26, 2022
(86) PCT No.: PCT/CN2022/141880

§ 371 Date: Oct. 29, 2024

(51) Int. Cl. G05B 19/4155

(52) U.S. Cl. CPC G05B 19/4155; G05B 2219/31372

(57) ABSTRACT

A computer-implemented method is provided. The computer-implemented method includes obtaining data on a plurality of materials for making one or more products; identifying a first group of one or more materials from the plurality of materials, a respective material in the first group is a replaceable material with respect to at least one of the one or more product; calculating a maximum consumption of the respective material in the first group in a period using a linear programming model with respect to the at least one of the one or more product; comparing the maximum consumption of the respective material in the first group in the period with an available inventory amount of the respective material in the first group; and determining whether the respective material in the first group is overstocked in the period.

### TECHNICAL FIELD

The present invention relates to display technology, more particularly, to a computer-implemented method, an apparatus for managing production of one or more products, and a computer-program product.

### BACKGROUND

Management of production of products is a complicated process, particularly when the process involves a large number of products and starting materials. In manufacturing a product, the management becomes more difficult when the demand for products and engineering for manufacturing processes can quickly change over a short period of time. Traditional manual management or simple programming are insufficient to manage production, often resulting in material overstock and waste.

### SUMMARY

In one aspect, the present disclosure provides a computer-implemented method, comprising obtaining data on a plurality of materials for making one or more products; identifying a first group of one or more materials from the plurality of materials, a respective material in the first group is a replaceable material with respect to at least one of the one or more product; calculating a maximum consumption of the respective material in the first group in a period using a linear programming model with respect to the at least one of the one or more product; comparing the maximum consumption of the respective material in the first group in the period with an available inventory amount of the respective material in the first group; and determining whether the respective material in the first group is overstocked in the period.

Optionally, an objective function for the linear programming model is expressed as obj=maxΣᵢ₌₁^{N}dᵢ*xᵢ; wherein xᵢ stands for an amount of a respective product that can be produced in the period using the respective material in the first group; dᵢ stands for a unit consumption of the respective material in the first group with respect to the respective product; and N is a positive integer, N≥1.

Optionally, the objective function is subject to a first constraint expressed as Σₓ_{ᵢ}_{∈(Q}_{ₗ}_{,G}_{ⱼ}₎xᵢ≤ Qₗ; wherein Qₗ stands for a demand for the respective product in the period; (Qₗ, Gⱼ) stands for a set of variables for a j-th group of materials that are substitutable for each other in producing the respective product; 0≤xᵢ≤Qₗ; and 1≤j≤J, wherein J stands for a total number of groups of materials that are substitutable for each other.

Optionally, wherein the objective function is subject to a second constraint expressed as Σₓ_{ᵢ}_{∈x}_{ₘ}dᵢ*xᵢ≤Cₘ, wherein Cₘ stands for an available inventory amount of a m-th material in the first group; Xₘ stands for a set of variables for the m-th material; and 1≤m≤M, wherein M stands a total number of materials in the first group.

Optionally, the computer-implemented method further comprises identifying a second group of one or more materials from the plurality of materials, a respective material in the second group is a non-replaceable material with respect to at least one of the one or more product; comparing a respective theoretical consumption of the respective material in the second group in the period with a respective inventory amount of the respective material in the second group; and determining that whether the respective material in the second group is overstocked in the period.

Optionally, upon determination that the respective theoretical consumption of the respective material in the second group in the period is equal to or greater than the respective inventory amount of the respective material in the second group, the computer-implemented method comprises determining that the respective material in the second group is not overstocked in the period.

Optionally, upon determination that the respective theoretical consumption of the respective material in the second group in the period is less than the respective inventory amount of the respective material in the second group, the computer-implemented method further comprises determining whether the respective material in the second group is a replaceable material with respect to another product of the one or more products.

Optionally, upon determination that the respective material in the second group is not a replaceable material with respect to any product of the one or more products, the computer-implemented method further comprises determining that the respective material in the second group is overstocked in the period.

Optionally, upon determination that the respective material in the second group is a replaceable material with respect to the another product, the computer-implemented method further comprises calculating a maximum consumption of the replaceable material in the period using a linear programming model with respect to the another; comparing the maximum consumption of the replaceable material in the period with an available inventory amount of the replaceable material; and determining whether the replaceable material is overstocked in the period; wherein the available inventory amount of the replaceable material is equal to the respective inventory amount subtracted by the respective theoretical consumption of the replaceable material in the period.

Optionally, the computer-implemented method further comprises calculating the respective theoretical consumption of the respective material in the second group in the period; wherein the respective theoretical consumption of the respective material in the second group in the period is equal to a sum of values of one or more demands in the period for one or more products requiring the respective material in the second group as a non-replaceable material respectively multiplied by respective unit consumptions of the respective material in the second group with respect to the one or more products.

Optionally, the computer-implemented method further comprises extracting data on materials in the first group from the data on the plurality of materials for making one or more products; and updating the data on materials in the first group upon determination an individual material in the first group is also a non-replaceable material with respect to another product of the one or more products.

Optionally, an available inventory amount of the individual material for the purpose of calculating a maximum consumption thereof is updated as being equal to an actual inventory amount of the individual material subtracted by a respective theoretical consumption in the period of the individual material as the non-replaceable material with respect to the another product.

Optionally, upon determination the respective material in the first group or the respective material in the second group is overstocked in the period, the computer-implemented method further comprises determining an overstock status for the respective material in the first group or the respective material in the second group that is overstocked in the period; wherein the overstock status is one of a first status, a second status, a third status, or a fourth status; wherein, in the first status, a demand for an overstocked material is zero in an entirety of the period; the period comprises a first sub-period followed by a second sub-period; in the second status, the demand for the overstocked material is zero in the second sub-period, and is non-zero in the first sub-period; in the third status, the demand for the overstocked material is zero in the first sub-period, and is non-zero in the second sub-period; and in the fourth status, the demand for the overstocked material is non-zero in the first sub-period, and is non-zero in the second sub-period.

Optionally, upon determination the respective material in the first group or the respective material in the second group is overstocked in the period, the computer-implemented method further comprises determining one or more underlying reasons for material overstock; and adjusting one or more production parameters in the period for the one or more products to minimize the material overstock.

Optionally, the data comprises data on priority level of the one or more materials in the first group; a higher priority level for a material in the first group indicates the material is more preferred in producing a corresponding product over one having a lower priority level.

Optionally, upon determination the respective material in the first group is overstocked in the period, the computer-implemented method further comprises adjusting the priority level of the respective material in the first group; and producing the one or more products based on adjusted priority level of the one or more materials in the first group.

Optionally, upon determination the respective material in the first group or the respective material in the second group is overstocked in the period, the computer-implemented method further comprises adjusting a demand in the period for the one or more products to minimize material overstock; and producing the one or more products based on adjusted demand in the period for the one or more products.

Optionally, the data on the plurality of materials comprises at least one of inventory amounts of the plurality of materials; demand for the one or more products in the period; information on substitution groups for the materials in the first group, materials that are substitutable for each other in producing a respective product being in a same substitution group; or priority levels for materials in the first group, a higher priority level for a first material in the same substitution group indicating the first material is more preferred in producing a corresponding product over a second material having a lower priority level in the same substitution group.

In another aspect, the present disclosure provides an apparatus for managing production of one or more products, comprising a memory; one or more processors; wherein the memory and the one or more processors are connected with each other; and the memory stores computer-executable instructions for controlling the one or more processors to obtain data on a plurality of materials for making one or more products; identify a first group of one or more materials from the plurality of materials, a respective material in the first group is a replaceable material with respect to at least one of the one or more product; calculate a maximum consumption of the respective material in the first group in a period using a linear programming model with respect to the at least one of the one or more product; compare the maximum consumption of the respective material in the first group in the period with an available inventory amount of the respective material in the first group; and determine whether the respective material in the first group is overstocked in the period.

In another aspect, the present disclosure provides a computer-program product, comprising a non-transitory tangible computer-readable medium having computer-readable instructions thereon, the computer-readable instructions being executable by a processor to cause the processor to perform obtaining data on a plurality of materials for making one or more products; identifying a first group of one or more materials from the plurality of materials, a respective material in the first group is a replaceable material with respect to at least one of the one or more product; calculating a maximum consumption of the respective material in the first group in a period using a linear programming model with respect to the at least one of the one or more product; comparing the maximum consumption of the respective material in the first group in the period with an available inventory amount of the respective material in the first group; and determining whether the respective material in the first group is overstocked in the period.

### BRIEF DESCRIPTION OF THE FIGURES

The following drawings are merely examples for illustrative purposes according to various disclosed embodiments and are not intended to limit the scope of the present invention.

FIG. 1 is a flow chart illustrating steps of a computer-implemented method in some embodiments according to the present disclosure.

FIG. 2 is a flow chart illustrating steps of a computer-implemented method in some embodiments according to the present disclosure.

FIG. 3 is a flow chart illustrating steps of a computer-implemented method in some embodiments according to the present disclosure.

FIG. 4 is a flow chart illustrating steps of a computer-implemented method in some embodiments according to the present disclosure.

FIG. 5 is a flow chart illustrating steps of a computer-implemented method in some embodiments according to the present disclosure.

FIG. 6 is a flow chart illustrating steps of a computer-implemented method in some embodiments according to the present disclosure.

FIG. 7 is a schematic diagram of a structure of an apparatus in some embodiments according to the present disclosure.

FIG. 8 is a schematic diagram illustrating one or more interfaces in some embodiments according to the present disclosure.

FIG. 9 illustrates a third output interface in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, a computer-implemented method, an apparatus for managing production of one or more products, and a computer-program product that substantially obviate one or more of the problems due to limitations and disadvantages of the related art. In one aspect, the present disclosure provides a computer-implemented method. In some embodiments, the computer-implemented method includes obtaining data on a plurality of materials for making one or more products; identifying a first group of one or more materials from the plurality of materials, a respective material in the first group is a replaceable material with respect to at least one of the one or more product; calculating a maximum consumption of the respective material in the first group in a period using a linear programming model with respect to the at least one of the one or more product; and comparing the maximum consumption of the respective material in the first group in the period with an available inventory amount of the respective material in the first group, and determining whether the respective material in the first group is overstocked in the period.

As used herein, the term “product” refers to any product produced by a plurality of materials. Examples of products include semiconductor products, electronic products, chemical products, mechanically assembled products, and so on. A product as used herein is not limited to a complete product. The term encompasses complete products and intermediate products.

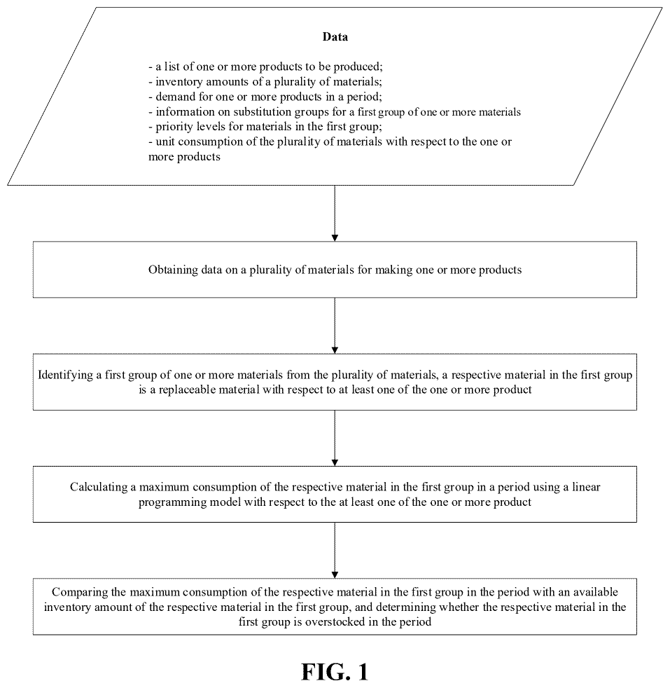

FIG. 1 is a flow chart illustrating steps of a computer-implemented method in some embodiments according to the present disclosure. Referring to FIG. 1, the computer-implemented method in some embodiments includes obtaining data on a plurality of materials for making one or more products; identifying a first group of one or more materials from the plurality of materials, a respective material in the first group is a replaceable material with respect to at least one of the one or more product; calculating a maximum consumption of the respective material in the first group in a period using a linear programming model with respect to the at least one of the one or more product; and comparing the maximum consumption of the respective material in the first group in the period with an available inventory amount of the respective material in the first group, and determining whether the respective material in the first group is overstocked in the period.

In some embodiments, the data on the plurality of materials for making one or more products may include at least one of a list of one or more products to be produced; inventory amounts of a plurality of materials; demand for one or more products in a period; information on substitution groups for a first group of one or more materials; priority levels for materials in the first group; or unit consumption of the plurality of materials with respect to the one or more products. With respect to the substitution groups, materials that are substitutable for each other in producing a respective product are in a same substitution group. With respect to the priority levels, a higher priority level for a first material in the same substitution group indicating the first material is more preferred in producing a corresponding product over a second material having a lower priority level in the same substitution group. Table 1 illustrates exemplary data on the plurality of materials for making one or more products in some embodiments according to the present disclosure.

TABLE 1
Data on the plurality of materials for making one or more products

| | | | | | | | | |
|---|---|---|---|---|---|---|---|---|
| Product | Material | Unit | Substitution | Priority | Inventory | Demand in | | Demand in |
| No. | No. | Consumption | Group | Level | Amount | Month 1 | . . . | Month 6 |

| | | | | | | | |
|---|---|---|---|---|---|---|---|
| PRO-1 | A | 1 | D1 | 1 | 5000 | 200 | 8000 |
| PRO-1 | B | 1 | D1 | 2 | 2000 | 200 | 8000 |
| PRO-1 | C | 2 | D2 | 1 | 3000 | 200 | 8000 |
| PRO-1 | D | 2 | D2 | 2 | 1000 | 200 | 8000 |
| PRO-1 | E | 4 | Null | 0 | 2500 | 200 | 8000 |
| PRO-2 | A | 2 | Null | 0 | 5000 | 500 | 200 |
| PRO-2 | F | 2 | Null | 0 | 2000 | 500 | 200 |

As shown in Table 1, the data on the plurality of materials for making one or more products in some embodiments includes a list of products as indicated by product numbers, e.g., PRO-1 and PRO-2; and a list of materials as indicated by material numbers, e.g., A, B, C, D, E, and F. The data further includes unit consumption of the plurality of materials with respect to the one or more products. A same material may have different unit consumption with respect to different products. For example, both PRO-1 and PRO-2 may use material No. A as an ingredient in production, the unit consumption of material A with respect to PRO-1 is 1, and the unit consumption of material A with respect to PRO-2 is 2. A unit consumption is a ratio of an amount (either in weight or mole) of the material required to be consumed to produce an amount of a product to the amount of the product.

A same substitution group includes materials that are substitutable for each other in producing a same product. For example, material A and material B are substitutable for each other in producing product PRO-1, material A and material B are in a same substitution group D1. Material C and material D are substitutable for each other in producing product PRO-1, material C and material D are in a same substitution group D2. Product PRO-1 may be produced by four different combinations of materials, including (A, D, E), (A, C, E), (B, D, E), and (B, C, E).

A higher priority level for a first material in the same substitution group indicating the first material is more preferred in producing a corresponding product over a second material having a lower priority level in the same substitution group. For example, Material A has a priority level of 1, material B has a priority level of 2, material A is more preferred in producing product PRO-1 over material B. In Table 1, a smaller number for the priority level indicates a higher priority, e.g., more preferred.

A first group of one or more materials may be identified from the plurality of materials. A respective material in the first group is a replaceable material with respect to at least one of the one or more product. In Table 1, a material that may be identified as a material in the first group with respect to a particular product is denoted by having a non-null value for the “Substitution Group” column. Optionally, the non-null value may be denoted as Dn, wherein n stands for a substitution group number. Table 1 describes a substitution group number 1 (“D1”) and a substitution group number 2 (“D2”). The substitution group number 1 (“D1”) includes materials A and B with respect to product PRO-1. The substitution group number 2 (“D2”) includes materials C and D with respect to product PRO-1. As shown in Table 1, materials A, B, C, D may be identified as the materials in the first group, wherein each of materials A, B, C, D may be replaceable with respect to at least one of the one or more product. For example, material A is replaceable by material B with respect to product PRO-1; material C is replaceable by material D with respect to product PRO-2.

A second group of one or more materials may be identified from the plurality of materials. A respective material in the second group is a non-replaceable material with respect to at least one of the one or more product. In Table 1, a material that may be identified as a material in the second group with respect to a particular product is denoted by “Null” in the “Substitution Group” column. As shown in Table 1, materials A, E, and F may be identified as the materials in the second group, wherein each of materials A, E, and F is non-replaceable with respect to at least one of the one or more product. For example, material A is non-replaceable with respect to product PRO-2; material E is non-replaceable with respect to product PRO-1; and material F is non-replaceable with respect to product PRO-2.

A same material may be in the first group with respect to a first product, but in the second group with respect to a second product. Thus, the first group and the second group may have an intersection. For example, material A is in the first group with respect to product PRO-1, but in the second group with respect to product PRO-2.

Referring to Table 1, each of the materials in the second group may be assigned a “null” value for substitution group, and may be assigned a “0” for priority level.

As shown in Table 1, the data on the plurality of materials for making one or more products in some embodiments further includes inventory amount for each of the plurality of materials, and demand for each of the plurality of materials. The demand for each of the plurality of materials may be listed by, for example, month. Tables shows the demand for each of the plurality of materials in Month 1 to Month 6. In one example, the period is six month, and the step of calculating a maximum consumption of the respective material in the first group is performed for a period of six months.

In some embodiments, the period includes at least a sub-period in the future. Optionally, the period is entirety a period in the future, for example, a period of next six month. Optionally, the period includes a sub-period in the past and a sub-period in the future, for example, a period of last three months and next three months. Related production management methods are typically based on simple analysis and statistical calculation of historical consumption and replenishment information, and present the historical occurrence of material overstock. The computer-implemented method according to the present disclosure is based on inventory information and demand on products at least partially (e.g., entirely) in the future, to determine material overstock status with the goal of maximizing material consumption.

In some embodiments, the computer-implemented method further includes extracting data on materials in the first group from the data on the plurality of materials for making one or more products. Table 2 illustrates exemplary data on the materials in the first group in some embodiments according to the present disclosure.

TABLE 2
Data on materials in a first group in some embodiments according to the present disclosure

| | | | | | | | | |
|---|---|---|---|---|---|---|---|---|
| Product | Material | Unit | Substitution | Priority | Inventory | Demand in | | Demand in |
| No. | No. | Consumption | Group | Level | Amount | Month 1 | . . . | Month 6 |

| | | | | | | | |
|---|---|---|---|---|---|---|---|
| PRO-1 | A | 1 | D1 | 1 | 5000 | 200 | 8000 |
| PRO-1 | B | 1 | D1 | 2 | 2000 | 200 | 8000 |
| PRO-1 | C | 2 | D2 | 1 | 3000 | 200 | 8000 |
| PRO-1 | D | 2 | D2 | 2 | 1000 | 200 | 8000 |

In some embodiments, extracting data on materials in the first group from the data on the plurality of materials for making one or more products includes extracting data having a field value for substitution group that is not null, or data having a field value for priority level that is not zero.

Various appropriate linear programming models may be used for calculating the maximum consumption of the respective material in the first group in the period with respect to the at least one of the one or more product. In some embodiments, the linear programming model is an integer linear programming model. In one example, the linear programming model is a pure integer linear programming model, in which all variables are integers. In another example, the linear programming model is a mixed integer linear programming model, in which some variables are integers, and some are non-integers.

Various appropriate approaches may be implemented in the linear programming model. In one example, a branch-and-bound approach may be used, which is based on the principle that the total set of feasible solutions can be partitioned into smaller subsets of solutions. The smaller subsets can then be evaluated systematically until the best solution is found. The branch-and-bound approach may be implemented in either the pure integer linear programming model or in the mixed integer linear programming model. In another example, a cutting plane approach may be used, which iteratively refers a feasible set or objective function by means of linear inequalities, termed cuts. The cutting plane approach may be implemented in either the pure integer linear programming model or in the mixed integer linear programming model.

In some embodiments, an objective function for the linear programming model is expressed as:

$$obj = max {\sum }_{i = 1}^{N} {d}_{i} * {x}_{i} ;$$

wherein xᵢ stands for an amount of a respective product that can be produced in the period using the respective material in the first group; dᵢ stands for a unit consumption of the respective material in the first group with respect to the respective product; and N is a positive integer, N≥1. In one example, N stands for a total number of materials in the first group. In one example, xᵢ may be a total number of the respective product that can be produced in the period using the respective material in the first group. In another example, dᵢ may be grams of the respective material in the first group with respect to the respective product for producing one respective product.

In some embodiments, the objective function is subject to a first constraint expressed as:

Σₓ_{ᵢ}_{∈(Q}_{ₗ}_{,G}_{ⱼ}₎xᵢ≤Qₗ;

wherein Qₗ stands for a demand for the respective product in the period; (Qₗ, Gⱼ) stands for a set of variables for a j-th group of materials that are substitutable for each other in producing the respective product; and 0≤xᵢ≤Qₗ. Referring to Table 2, in one example, there are two groups of materials that are substitutable for each other in producing the respective product, including a group comprising A and B that are substitutable for each other in producing PRO-1, and a group comprising C and D that are substitutable for each other in producing PRO-1. Optionally, 1≤j≤J, wherein J stands for a total number of groups of materials that are substitutable for each other.

In some embodiments, the objective function is subject to a second constraint expressed as:

$${\sum }_{{x}_{i} ∈ {X}_{m}} {d}_{i} * {x}_{i} \leq {C}_{m} ;$$

wherein Cₘ stands for an available inventory amount of a m-th material in the first group; and Xₘ stands for a set of variables for the m-th material. Optionally, 1≤m≤M, wherein M stands a total number of materials in the first group.

In some embodiments, an individual material in the first group is a replaceable material with respect to one product but non-replaceable material with respect to another product (e.g., in a second group with respect to the another product). A theoretical consumption of the individual material in the period is calculated with respect to the another product. In calculating the maximum consumption of the individual material in the period, and comparing the maximum consumption of the individual material with an available inventory amount of the individual material, to determining whether the individual material is overstocked in the period, the available inventory amount (e.g., Cₘ) of the individual material is equal to a respective inventory amount (e.g., an actual inventory amount) of the individual material subtracted by the respective theoretical consumption of the individual material in the period.

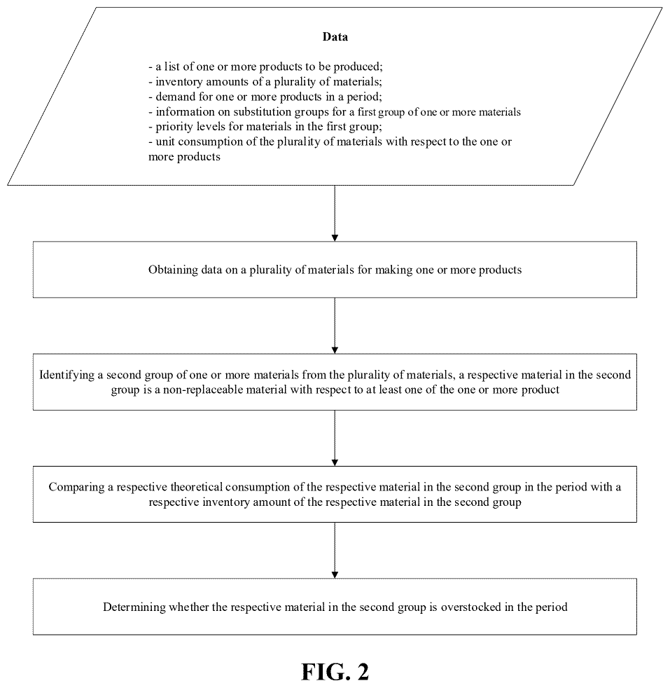

FIG. 2 is a flow chart illustrating steps of a computer-implemented method in some embodiments according to the present disclosure. Referring to FIG. 2, the computer-implemented method in some embodiments includes obtaining data on a plurality of materials for making one or more products; identifying a second group of one or more materials from the plurality of materials, a respective material in the second group is a non-replaceable material with respect to at least one of the one or more product; comparing a respective theoretical consumption of the respective material in the second group in the period with a respective inventory amount of the respective material in the second group; and determining whether the respective material in the second group is overstocked in the period.

In some embodiments, the computer-implemented method further includes extracting data on materials in the second group from the data on the plurality of materials for making one or more products. Table 3 illustrates exemplary data on the materials in the second group in some embodiments according to the present disclosure.

TABLE 3
Data on materials in a second group in some embodiments according to the present disclosure

| | | | | | | | | |
|---|---|---|---|---|---|---|---|---|
| Product | Material | Unit | Substitution | Priority | Inventory | Demand in | | Demand in |
| No. | No. | Consumption | Group | Level | Amount | Month 1 | . . . | Month 6 |

| | | | | | | | |
|---|---|---|---|---|---|---|---|
| PRO-1 | E | 4 | Null | 0 | 2500 | 200 | 8000 |
| PRO-2 | A | 2 | Null | 0 | 5000 | 500 | 200 |
| PRO-2 | F | 2 | Null | 0 | 2000 | 500 | 200 |

In some embodiments, extracting data on materials in the second group from the data on the plurality of materials for making one or more products includes extracting data having a field value for substitution group that is null, or data having a field value for priority level that is zero.

In some embodiments, the computer-implemented method further includes calculating the respective theoretical consumption of the respective material in the second group in the period. Optionally, the respective theoretical consumption of the respective material in the second group in the period is equal to a sum of values of one or more demands in the period for one or more products requiring the respective material in the second group as a non-replaceable material respectively multiplied by respective unit consumptions of the respective material in the second group with respect to the one or more products. In one example, referring to Table 3, a theoretical consumption of material E is equal to a demand for PRO-1 multiplied by unit consumption of material E with respect to PRO-1, which is equal to 20000*4.

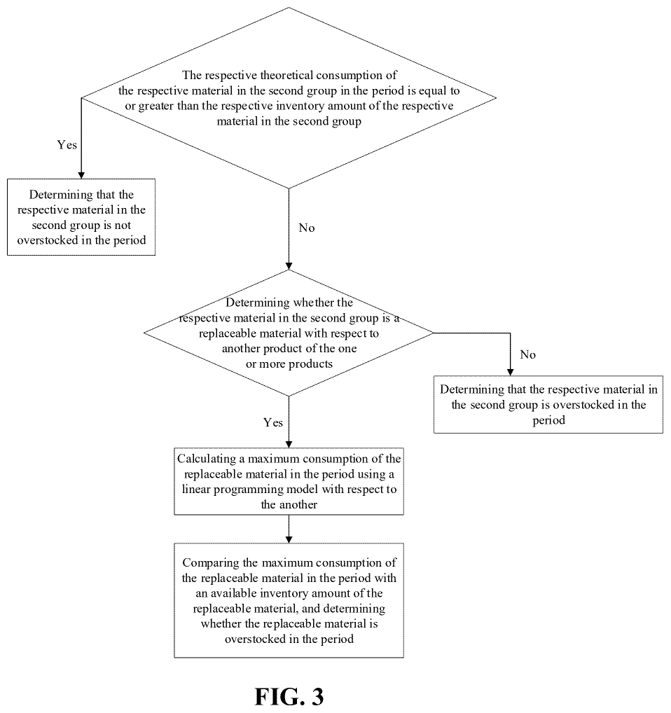

FIG. 3 is a flow chart illustrating steps of a computer-implemented method in some embodiments according to the present disclosure. Referring to FIG. 3, in some embodiments, upon determination that the respective theoretical consumption of the respective material in the second group in the period is equal to or greater than the respective inventory amount of the respective material in the second group, the computer-implemented method further includes determining that the respective material in the second group is not overstocked in the period.

Referring to FIG. 3, in some embodiments, upon determination that the respective theoretical consumption of the respective material in the second group in the period is less than the respective inventory amount of the respective material in the second group, the computer-implemented method further includes determining whether the respective material in the second group is a replaceable material with respect to another product of the one or more products.

Referring to FIG. 3, in some embodiments, upon determination that the respective material in the second group is not a replaceable material with respect to any product of the one or more products, the computer-implemented method further includes determining that the respective material in the second group is overstocked in the period.

Referring to FIG. 3, in some embodiments, upon determination that the respective material in the second group is a replaceable material with respect to the another product, the computer-implemented method further includes calculating a maximum consumption of the replaceable material in the period using a linear programming model with respect to the another; and comparing the maximum consumption of the replaceable material in the period with an available inventory amount of the replaceable material, and determining whether the replaceable material is overstocked in the period. The available inventory amount of the replaceable material is equal to the respective inventory amount subtracted by the respective theoretical consumption of the replaceable material in the period.

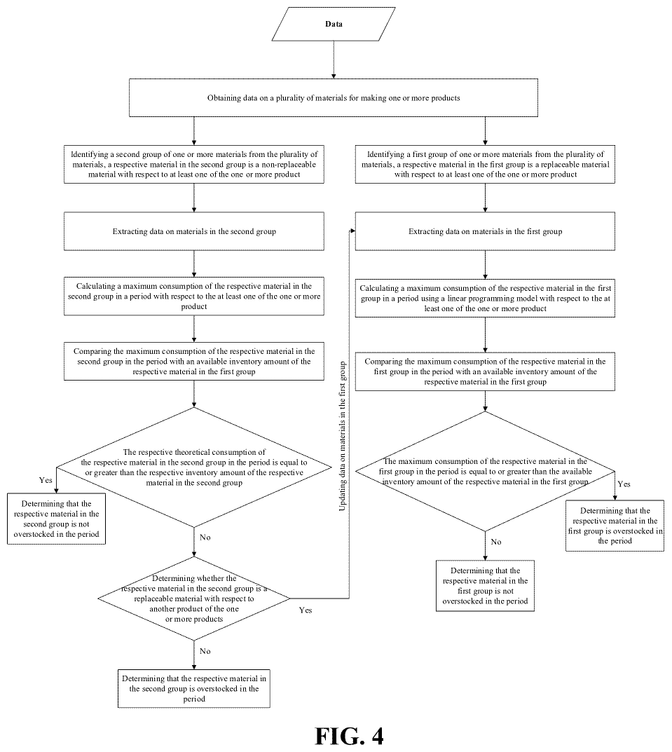

FIG. 4 is a flow chart illustrating steps of a computer-implemented method in some embodiments according to the present disclosure. Referring to FIG. 4, the computer-implemented method in some embodiments includes obtaining data on a plurality of materials for making one or more products; identifying a second group of one or more materials from the plurality of materials, a respective material in the second group is a non-replaceable material with respect to at least one of the one or more product; extracting data on materials in the second group; calculating a maximum consumption of the respective material in the second group in a period with respect to the at least one of the one or more product; comparing the maximum consumption of the respective material in the second group in the period with an available inventory amount of the respective material in the second group; and determining whether the respective theoretical consumption of the respective material in the second group in the period is equal to or greater than the respective inventory amount of the respective material in the second group.

In some embodiments, the computer-implemented method further includes identifying a first group of one or more materials from the plurality of materials, a respective material in the first group is a replaceable material with respect to at least one of the one or more product; and extracting data on materials in the first group.

Upon determination the respective theoretical consumption of the respective material in the second group in the period is equal to or greater than the respective inventory amount of the respective material in the second group, the computer-implemented method in some embodiments includes determining that the respective material in the second group is not overstocked in the period.

Upon determination the respective theoretical consumption of the respective material in the second group in the period is less than the respective inventory amount of the respective material in the second group, the computer-implemented method in some embodiments includes determining whether the respective material in the second group is a replaceable material with respect to another product of the one or more products.

Upon determination the respective material in the second group is not a replaceable material with respect to another product of the one or more products, the computer-implemented method in some embodiments includes determining that the respective material in the second group is overstocked in the period.

Upon determination the respective material in the second group is a replaceable material with respect to another product of the one or more products, the computer-implemented method in some embodiments includes updating data on materials in the first group. For example, the replaceable material is the respective material in the second group with respect to a first product, and is an individual material in the first group with respect to a second product. An available inventory amount of the individual material in the first group with respect to the second product is updated as being equal to an actual inventory amount subtracted by the respective theoretical consumption of the replaceable material (when treated as the respective material in the second group) with respect to the first product in the period.

Referring to FIG. 4, the computer-implemented method in some embodiments further includes identifying a first group of one or more materials from the plurality of materials, a respective material in the first group is a replaceable material with respect to at least one of the one or more product; extracting data on materials in the first group; and optionally updating the data on materials in the first group as discussed above.

In some embodiments, the computer-implemented method further includes calculating a maximum consumption of the respective material in the first group in a period using a linear programming model with respect to the at least one of the one or more product; comparing the maximum consumption of the respective material in the first group in the period with an available inventory amount of the respective material in the first group; and determining whether the maximum consumption of the respective material in the first group in the period is equal to or greater than the available inventory amount of the respective material in the first group.

Upon determination the maximum consumption of the respective material in the first group in the period is equal to or greater than the available inventory amount of the respective material in the first group, the computer-implemented method further includes determining that the respective material in the first group is overstocked in the period.

Upon determination the maximum consumption of the respective material in the first group in the period is less than the available inventory amount of the respective material in the first group, the computer-implemented method further includes determining that the respective material in the first group is not overstocked in the period.

Accordingly, as shown in FIG. 4, when the plurality materials include both the first group of one or more materials and the second group of one or more materials, the method in some embodiments includes a plurality of first steps and a plurality of second steps. At least one first step of the plurality of first steps is performed prior to performing at least one second step of the plurality of second steps. Optionally, all of the plurality of first steps is performed prior to performing any of the plurality of second steps. Optionally, the plurality of first steps include at least one of identifying a second group of one or more materials from the plurality of materials, a respective material in the second group is a non-replaceable material with respect to at least one of the one or more product; comparing a respective theoretical consumption of the respective material in the second group in the period with a respective inventory amount of the respective material in the second group; or determining that whether the respective material in the second group is overstocked in the period. Optionally, the plurality of second steps include at least one of identifying a first group of one or more materials from the plurality of materials, a respective material in the first group is a replaceable material with respect to at least one of the one or more product; calculating a maximum consumption of the respective material in the first group in a period using a linear programming model with respect to the at least one of the one or more product; comparing the maximum consumption of the respective material in the first group in the period with an available inventory amount of the respective material in the first group; or determining whether the respective material in the first group is overstocked in the period.

In one example, determining that whether the respective material in the second group is overstocked in the period is performed prior to performing calculating a maximum consumption of the respective material in the first group in a period using a linear programming model with respect to the at least one of the one or more product. In another example, comparing a respective theoretical consumption of the respective material in the second group in the period with a respective inventory amount of the respective material in the second group is performed prior to performing calculating a maximum consumption of the respective material in the first group in a period using a linear programming model with respect to the at least one of the one or more product.

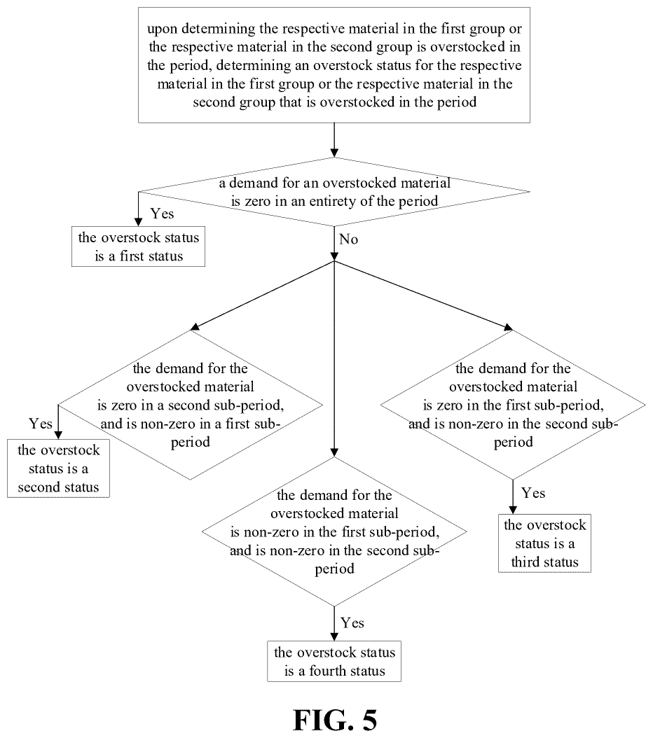

FIG. 5 is a flow chart illustrating steps of a computer-implemented method in some embodiments according to the present disclosure. Referring to FIG. 5, the computer-implemented method in some embodiments further includes, upon determination the respective material in the first group or the respective material in the second group is overstocked in the period, further comprising determining an overstock status for the respective material in the first group or the respective material in the second group that is overstocked in the period.

In some embodiments, the computer-implemented method further includes determining whether a demand for an overstocked material is zero in an entirety of the period. Upon determination the demand for the overstocked material is zero in an entirety of the period, the computer-implemented method further includes determining the overstock status as a first status.

In some embodiments, the period comprises a first sub-period followed by a second sub-period; the computer-implemented method further includes determining whether the demand for the overstocked material is zero in the second sub-period, and is non-zero in the first sub-period. In one example, the period is a period of six months, the first sub-period is month 1 to month 3; and the second sub-period is month 4 to month 6. Upon determination the demand for the overstocked material is zero in the second sub-period, and is non-zero in the first sub-period, the computer-implemented method further includes determining the overstock status as a second status.

In some embodiments, the computer-implemented method further includes determining whether the demand for the overstocked material is zero in the first sub-period, and is non-zero in the second sub-period. Upon determination the demand for the overstocked material is zero in the first sub-period, and is non-zero in the second sub-period, the computer-implemented method further includes determining the overstock status as a third status.

In some embodiments, the computer-implemented method further includes determining whether the demand for the overstocked material is non-zero in the first sub-period, and is non-zero in the second sub-period. Upon determination the demand for the overstocked material is non-zero in the first sub-period, and is non-zero in the second sub-period, the computer-implemented method further includes determining the overstock status as a fourth status.

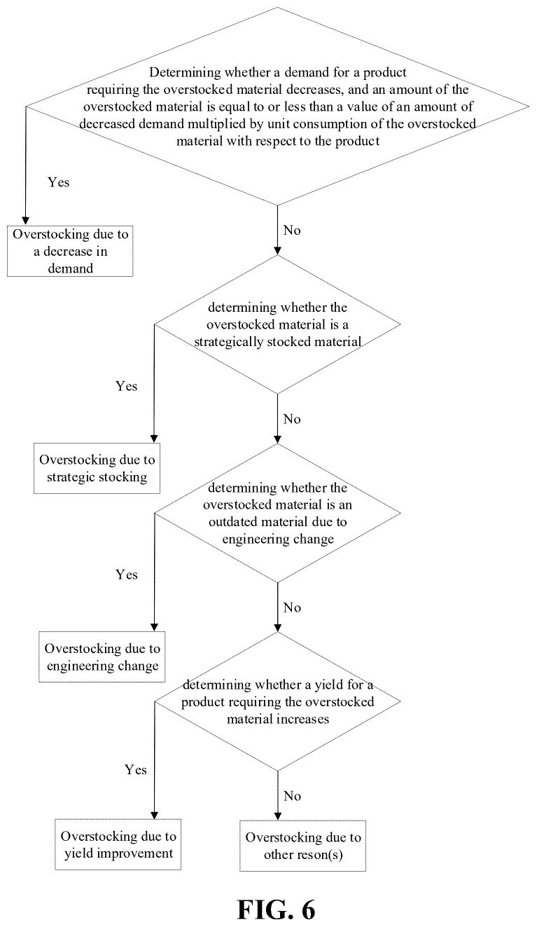

In some embodiments, the computer-implemented method further includes analyzing an underlying reason for overstocking. FIG. 6 is a flow chart illustrating steps of a computer-implemented method in some embodiments according to the present disclosure. Referring to FIG. 6, the computer-implemented method in some embodiments further includes determining whether a demand for a product requiring the overstocked material decreases, and an amount of the overstocked material is equal to or less than a value of an amount of decreased demand multiplied by unit consumption of the overstocked material with respect to the product. Upon determination the demand for the product requiring the overstocked material decreases, and the amount of the overstocked material is equal to or less than the value of the amount of decreased demand multiplied by unit consumption of the overstocked material with respect to the product, the computer-implemented method further includes determining that the underlying reason for overstocking is due to a decrease in demand.

In some embodiments, the computer-implemented method further includes determining whether the overstocked material is a strategically stocked material. Upon determination the overstocked material is a strategically stocked material, the computer-implemented method further includes determining that the underlying reason for overstocking is due to strategic stocking.

In some embodiments, the computer-implemented method further includes determining whether the overstocked material is an outdated material due to engineering change. Upon determination the overstocked material is an outdated material due to engineering change, the computer-implemented method further includes determining that the underlying reason for overstocking is due to engineering change.

In some embodiments, the computer-implemented method further includes determining whether a yield for a product requiring the overstocked material increases. Upon determination the yield for the product requiring the overstocked material increases, the computer-implemented method further includes determining that the underlying reason for overstocking is due to yield improvement.

The order of steps of determining the underlying reason for overstocking depicted in FIG. 6 may be modified in any appropriate manner. For example, the method may first determine whether overstocking is due to yield improvement, then determining whether overstocking is due to engineering change.

In some embodiments, upon determination of one or more underlying reasons for material overstock, the computer-implemented method further includes adjust one or more production parameters in the period for the one or more products to minimize the material overstock. In some embodiments, the data on the plurality of materials for making one or more products includes data on priority level of the one or more materials in the first group. A higher priority level for a material in the first group indicates the material is more preferred in producing a corresponding product over one having a lower priority level. In some embodiments, upon determination the respective material in the first group is overstocked in the period, the computer-implemented method further includes adjusting the priority level of the respective material in the first group; and producing the one or more products based on adjusted priority level of the one or more materials in the first group. By adjusting the priority level of the respective material (e.g., the overstocked material) in the first group, inventory costs and material overstock can be lowered.

In some embodiments, upon determination the respective material in the first group is overstocked in the period, the computer-implemented method further includes adjusting a demand in the period for the one or more products to minimize material overstock; and producing the one or more products based on adjusted demand in the period for the one or more products. By adjusting the demand in the period for the one or more products, the material overstock may be lowered, the manufacturer can better cater to the market, and the products may be made available faster.

In some embodiments, the computer-implemented method further includes generating one or more user interfaces. In some embodiments, the one or more user interfaces includes a first output interface configured to display an overstock status for the respective material in the first group or the respective material in the second group that is overstocked in the period. The overstock status indicates the reason or reasons for overstocking. In some embodiments, the first output interface is configured to display an identification number for an overstocked material in the period, and the overstock status associated with the overstocked material. In some embodiments, the overstock status is selected from a group consisting of a first status, a second status, a third status, and a fourth status. The first status indicates that a demand for an overstocked material is zero in an entirety of the period. The second status indicates that a demand for an overstocked material is zero in a second sub-period in the period, and is non-zero in a first sub-period in the period, wherein the first sub-period is followed by the second sub-period. The third status indicates that a demand for an overstocked material is zero in a first sub-period in the period, and is non-zero in a second sub-period in the period, wherein the first sub-period is followed by the second sub-period. The fourth status indicates that a demand for an overstocked material is non-zero in a first sub-period in the period, and is non-zero in a second sub-period in the period, wherein the first sub-period is followed by the second sub-period.

In some embodiments, the first output interface is further configured to display at least one of an identification number for a manufacturing site having the overstocked material or a classification of the overstocked material.

In some embodiments, the one or more user interfaces further includes a first input interface configured to receive one or more user inputs for querying a database. In some embodiments, the method includes receiving, from the first input interface, a user selection of one or more conditions for selecting an overstocked material associated with the one or more conditions; in response to the user selection, and querying the database to determine one or more overstocked materials in the database associated with the one or more conditions. The one or more conditions in some embodiments include an overstock status as discussed above. Optionally, the one or more conditions further include at least one of an identification number for a manufacturing site, an identification number for a material, or a range of dates.

In some embodiments, the one or more user interfaces further includes a second output interface configured to display the one or more overstocked materials as a result of the querying the database. Optionally, the second output interface is further configured to display an identification number for one or more products produced by the one or more overstocked materials. Optionally, the second output interface is further configured to display a demand for an overstocked material for making a respective product, e.g., in a most recent period (including a first sub-period and a second sub-period). The user can analyze the relationship between the demand and the overstock status.

In some embodiments, the one or more user interfaces further includes a second input interface configured to receive one or more user inputs for adjusting the priority level of the respective material in the first group. Based on an adjusted priority level of the respective material in the first group, the method includes re-determining the respective material in the first group is overstocked in the period. By adjusting the priority level of the respective material (e.g., the overstocked material) in the first group, inventory costs and material overstock can be lowered.

In some embodiments, the one or more user interfaces further includes a third input interface configured to receive one or more user inputs for adjusting the demand in the period for the one or more products. Based on an adjusted demand in the period for the one or more products, the method includes calculating an adjusted maximum consumption of the respective material in the first group in the period; comparing the adjusted maximum consumption of the respective material in the first group in the period with an available inventory amount of the respective material in the first group; and re-determining whether the respective material in the first group is overstocked in the period. By adjusting the demand in the period for the one or more products, the material overstock may be lowered, the manufacturer can better cater to the market, and the products may be made available faster.

In some embodiments, the one or more user interfaces further includes a third output interface configured to display an estimated surplus amount with respect to an overstock material at a first manufacturing site and an estimated deficit amount with respect the overstock material at a second manufacturing site. Optionally, the third output interface is configured to display a table comprising an identification number of the overstocked material, identification numbers of the manufacturing sites, the estimated surplus amount, and the estimated deficit amount. In some embodiments, the user may allocate the overstock material between manufacturing sites based on several factors including transportation cost, how urgent the overstock material is needed in the second manufacturing site, and so on.

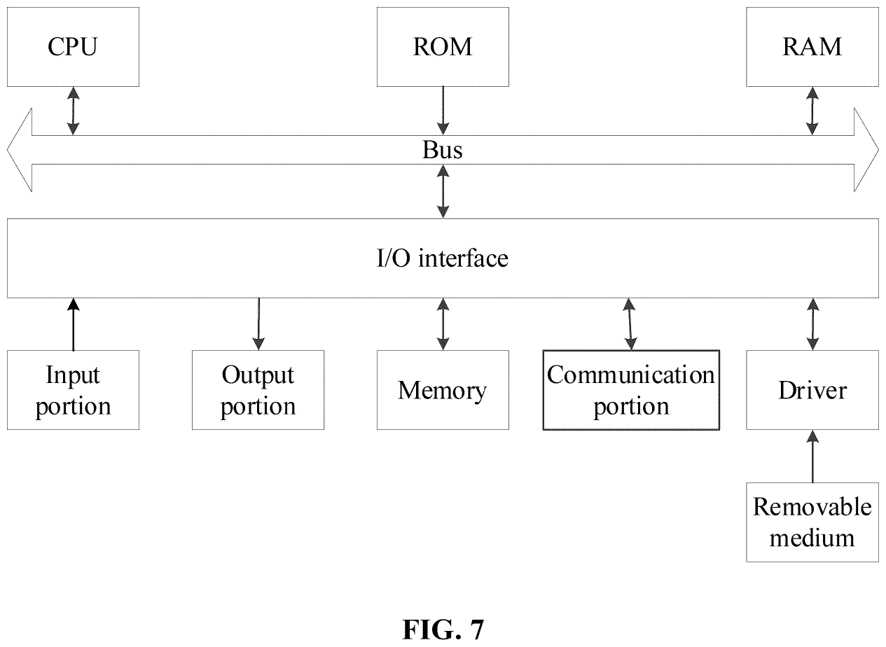

In another aspect, the present disclosure provides an apparatus for managing production of one or more products. FIG. 7 is a schematic diagram of a structure of an apparatus in some embodiments according to the present disclosure. Referring to FIG. 7, in some embodiments, the apparatus includes the central processing unit (CPU) configured to perform actions according to the computer-executable instructions stored in a ROM or in a RAM. Optionally, data and programs required for a computer system are stored in RAM. Optionally, the CPU, the ROM, and the RAM are electrically connected to each other via bus. Optionally, an input/output interface is electrically connected to the bus.

In some embodiments, the apparatus includes a memory, and one or more processors, wherein the memory and the one or more processors are connected with each other. In some embodiments, the memory stores computer-executable instructions for controlling the one or more processors to obtain data on a plurality of materials for making one or more products; identify a first group of one or more materials from the plurality of materials, a respective material in the first group is a replaceable material with respect to at least one of the one or more product; calculate a maximum consumption of the respective material in the first group in a period using a linear programming model with respect to the at least one of the one or more product; compare the maximum consumption of the respective material in the first group in the period with an available inventory amount of the respective material in the first group; and determine whether the respective material in the first group is overstocked in the period.

In some embodiments, an objective function for the linear programming model is expressed as:

$$obj = max {\sum }_{i = 1}^{N} {d}_{i} * {x}_{i} ;$$

wherein xᵢ stands for an amount of a respective product that can be produced in the period using the respective material in the first group; dᵢ stands for a unit consumption of the respective material in the first group with respect to the respective product; and N is a positive integer, N≥1.

In some embodiments, the objective function is subject to a first constraint expressed as:

Σₓ_{ᵢ}_{∈(Q}_{ₗ}_{,G}_{ⱼ}₎xᵢ≤Qₗ;

I wherein Qₗ stands for a demand for the respective product in the period; (Qₗ, Gⱼ) stands for a set of variables for a j-th group of materials that are substitutable for each other in producing the respective product; 0≤xᵢ≤<Q; and 1≤j≤J, wherein J stands for a total number of groups of materials that are substitutable for each other.

In some embodiments, the objective function is subject to a second constraint expressed as:

$${\sum }_{{x}_{i} ∈ {X}_{m}} {d}_{i} * {x}_{i} \leq {C}_{m} ;$$

wherein Cₘ stands for an available inventory amount of a m-th material in the first group; Xₘ stands for a set of variables for the m-th material; and 1≤m & M, wherein M stands a total number of materials in the first group.

In some embodiments, the memory further stores computer-executable instructions for controlling the one or more processors to identify a second group of one or more materials from the plurality of materials, a respective material in the second group is a non-replaceable material with respect to at least one of the one or more product; compare a respective theoretical consumption of the respective material in the second group in the period with a respective inventory amount of the respective material in the second group; and determine that whether the respective material in the second group is overstocked in the period.

In some embodiments, the memory further stores computer-executable instructions for controlling the one or more processors to, upon determination that the respective theoretical consumption of the respective material in the second group in the period is equal to or greater than the respective inventory amount of the respective material in the second group, determine that the respective material in the second group is not overstocked in the period.

In some embodiments, the memory further stores computer-executable instructions for controlling the one or more processors to, upon determination that the respective theoretical consumption of the respective material in the second group in the period is less than the respective inventory amount of the respective material in the second group, determine whether the respective material in the second group is a replaceable material with respect to another product of the one or more products.

In some embodiments, the memory further stores computer-executable instructions for controlling the one or more processors to, upon determination that the respective material in the second group is not a replaceable material with respect to any product of the one or more products, determine that the respective material in the second group is overstocked in the period.

In some embodiments, the memory further stores computer-executable instructions for controlling the one or more processors to, upon determination that the respective material in the second group is a replaceable material with respect to the another product, calculate a maximum consumption of the replaceable material in the period using a linear programming model with respect to the another; compare the maximum consumption of the replaceable material in the period with an available inventory amount of the replaceable material; and determine whether the replaceable material is overstocked in the period. Optionally, the available inventory amount of the replaceable material is equal to the respective inventory amount subtracted by the respective theoretical consumption of the replaceable material in the period.

In some embodiments, the memory further stores computer-executable instructions for controlling the one or more processors to calculate the respective theoretical consumption of the respective material in the second group in the period. Optionally, the respective theoretical consumption of the respective material in the second group in the period is equal to a sum of values of one or more demands in the period for one or more products requiring the respective material in the second group as a non-replaceable material respectively multiplied by respective unit consumptions of the respective material in the second group with respect to the one or more products.

In some embodiments, the memory further stores computer-executable instructions for controlling the one or more processors to extract data on materials in the first group from the data on the plurality of materials for making one or more products; and update the data on materials in the first group upon determination an individual material in the first group is also a non-replaceable material with respect to another product of the one or more products.

In some embodiments, an available inventory amount of the individual material for the purpose of calculating a maximum consumption thereof is updated as being equal to an actual inventory amount of the individual material subtracted by a respective theoretical consumption in the period of the individual material as the non-replaceable material with respect to the another product.

In some embodiments, the memory further stores computer-executable instructions for controlling the one or more processors to, upon determining the respective material in the first group or the respective material in the second group is overstocked in the period, determine an overstock status for the respective material in the first group or the respective material in the second group that is overstocked in the period. In some embodiments, the overstock status is one of a first status, a second status, a third status, or a fourth status. Optionally, in the first status, a demand for an overstocked material is zero in an entirety of the period. Optionally, the period comprises a first sub-period followed by a second sub-period. Optionally, in the second status, the demand for the overstocked material is zero in the second sub-period, and is non-zero in the first sub-period. Optionally, in the third status, the demand for the overstocked material is zero in the first sub-period, and is non-zero in the second sub-period. Optionally, in the fourth status, the demand for the overstocked material is non-zero in the first sub-period, and is non-zero in the second sub-period.

In some embodiments, the memory further stores computer-executable instructions for controlling the one or more processors to, upon determining the respective material in the first group or the respective material in the second group is overstocked in the period, determine one or more underlying reasons for material overstock; and adjust one or more production parameters in the period for the one or more products to minimize the material overstock.

In some embodiments, the data comprises data on priority level of the one or more materials in the first group. Optionally, a higher priority level for a material in the first group indicates the material is more preferred in producing a corresponding product over one having a lower priority level.

In some embodiments, the memory further stores computer-executable instructions for controlling the one or more processors to, upon determination the respective material in the first group is overstocked in the period, adjust the priority level of the respective material in the first group; and produce the one or more products based on adjusted priority level of the one or more materials in the first group.

In some embodiments, the memory further stores computer-executable instructions for controlling the one or more processors to, upon determining the respective material in the first group or the respective material in the second group is overstocked in the period, adjust a demand in the period for the one or more products to minimize material overstock; and produce the one or more products based on adjusted demand in the period for the one or more products.

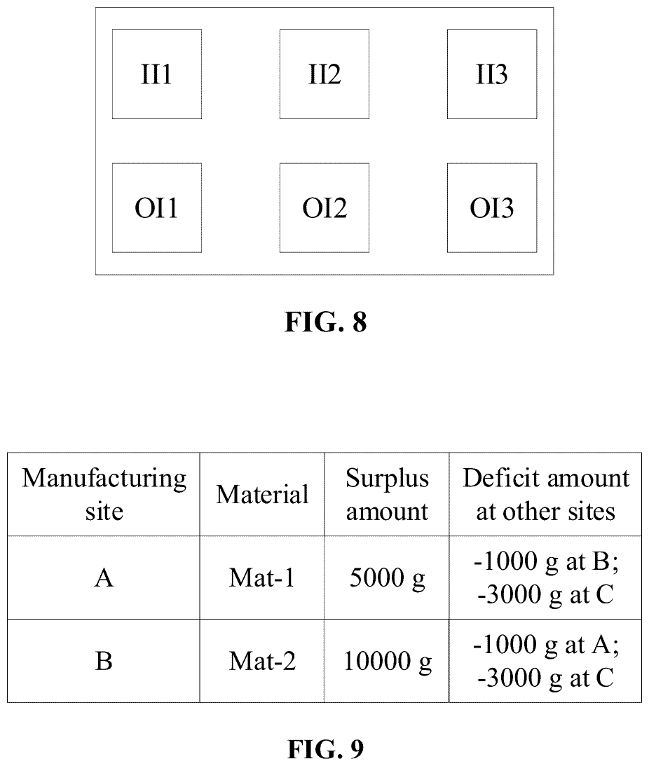

In some embodiments, the apparatus further includes one or more user interfaces. FIG. 8 is a schematic diagram illustrating one or more interfaces in some embodiments according to the present disclosure. Referring to FIG. 8, the one or more user interfaces in some embodiments includes a first input interface II1, a second input interface II2, a third input interface II3, a first output interface OI1, a second output interface OI2, and a third output interface OI3.

In some embodiments, the one or more user interfaces includes a first output interface OI1 configured to display an overstock status for the respective material in the first group or the respective material in the second group that is overstocked in the period. The overstock status indicates the reason or reasons for overstocking. In some embodiments, the first output interface OI1 is configured to display an identification number for an overstocked material in the period, and the overstock status associated with the overstocked material. In some embodiments, the overstock status is selected from a group consisting of a first status, a second status, a third status, and a fourth status. The first status indicates that a demand for an overstocked material is zero in an entirety of the period. The second status indicates that a demand for an overstocked material is zero in a second sub-period in the period, and is non-zero in a first sub-period in the period, wherein the first sub-period is followed by the second sub-period. The third status indicates that a demand for an overstocked material is zero in a first sub-period in the period, and is non-zero in a second sub-period in the period, wherein the first sub-period is followed by the second sub-period. The fourth status indicates that a demand for an overstocked material is non-zero in a first sub-period in the period, and is non-zero in a second sub-period in the period, wherein the first sub-period is followed by the second sub-period.

In some embodiments, the first output interface OI1 is further configured to display at least one of an identification number for a manufacturing site having the overstocked material or a classification of the overstocked material.

In some embodiments, the one or more user interfaces further includes a first input interface II1 configured to receive one or more user inputs for querying a database. In some embodiments, the method includes receiving, from the first input interface II1, a user selection of one or more conditions for selecting an overstocked material associated with the one or more conditions; in response to the user selection, and querying the database to determine one or more overstocked materials in the database associated with the one or more conditions. The one or more conditions in some embodiments include an overstock status as discussed above. Optionally, the one or more conditions further include at least one of an identification number for a manufacturing site, an identification number for a material, or a range of dates.

In some embodiments, the one or more user interfaces further includes a second output interface OI2 configured to display the one or more overstocked materials as a result of the querying the database. Optionally, the second output interface OI2 is further configured to display an identification number for one or more products produced by the one or more overstocked materials. Optionally, the second output interface OI2 is further configured to display a demand for an overstocked material for making a respective product, e.g., in a most recent period (including a first sub-period and a second sub-period). The user can analyze the relationship between the demand and the overstock status.

In some embodiments, the one or more user interfaces further includes a second input interface II2 configured to receive one or more user inputs for adjusting the priority level of the respective material in the first group. Based on an adjusted priority level of the respective material in the first group, the memory further stores computer-executable instructions for controlling the one or more processors to re-determine the respective material in the first group is overstocked in the period. By adjusting the priority level of the respective material (e.g., the overstocked material) in the first group, inventory costs and material overstock can be lowered.

In some embodiments, the one or more user interfaces further includes a third input interface II3 configured to receive one or more user inputs for adjusting the demand in the period for the one or more products. Based on an adjusted demand in the period for the one or more products, the memory further stores computer-executable instructions for controlling the one or more processors to calculate an adjusted maximum consumption of the respective material in the first group in the period; compare the adjusted maximum consumption of the respective material in the first group in the period with an available inventory amount of the respective material in the first group; and re-determine whether the respective material in the first group is overstocked in the period. By adjusting the demand in the period for the one or more products, the material overstock may be lowered, the manufacturer can better cater to the market, and the products may be made available faster.

In some embodiments, the one or more user interfaces further includes a third output interface OI3 configured to display an estimated surplus amount with respect to an overstock material at a first manufacturing site and an estimated deficit amount with respect the overstock material at a second manufacturing site. Optionally, the third output interface OI3 is configured to display a table comprising an identification number of the overstocked material, identification numbers of the manufacturing sites, the estimated surplus amount, and the estimated deficit amount.

FIG. 9 illustrates a third output interface in some embodiments according to the present disclosure. Referring to FIG. 9, the third output interface OI3 is configured to display that material Mat-1 is overstocked at the manufacturing site A by a surplus amount of 5000 g, and is deficit at the manufacturing site B by a deficit amount of 1000 g, and is deficit at the manufacturing site C by a deficit amount of 3000 g. In some embodiments, the user may allocate the overstock material between manufacturing sites based on several factors including transportation cost, how urgent the overstock material is needed in the second manufacturing site, and so on.

In another aspect, the present disclosure provides a computer-program product including a non-transitory tangible computer-readable medium having computer-readable instructions thereon. In some embodiments, the computer-readable instructions being executable by a processor to cause the processor to perform obtaining data on a plurality of materials for making one or more products; identifying a first group of one or more materials from the plurality of materials, a respective material in the first group is a replaceable material with respect to at least one of the one or more product; calculating a maximum consumption of the respective material in the first group in a period using a linear programming model with respect to the at least one of the one or more product; comparing the maximum consumption of the respective material in the first group in the period with an available inventory amount of the respective material in the first group; and determining whether the respective material in the first group is overstocked in the period.

In some embodiments, an objective function for the linear programming model is expressed as:

$$obj = max {\sum }_{i = 1}^{N} {d}_{i} * {x}_{i} ;$$

wherein xᵢ stands for an amount of a respective product that can be produced in the period using the respective material in the first group; dᵢ stands for a unit consumption of the respective material in the first group with respect to the respective product; and Nis a positive integer, N≥1.

In some embodiments, the objective function is subject to a first constraint expressed as:

Σₓ_{ᵢ}_{∈(Q}_{ₗ}_{,G}_{ⱼ}₎xᵢ≤Qₗ;

I wherein Qₗ stands for a demand for the respective product in the period; (Qₗ, Gⱼ) stands for a set of variables for a j-th group of materials that are substitutable for each other in producing the respective product; 0<xᵢ≤Qₗ; and 1≤j≤J, wherein J stands for a total number of groups of materials that are substitutable for each other.

In some embodiments, the objective function is subject to a second constraint expressed as:

$${\sum }_{{x}_{i} ∈ {X}_{m}} {d}_{i} * {x}_{i} \leq {C}_{m} ;$$

wherein Cₘ stands for an available inventory amount of a m-th material in the first group; Xₘ stands for a set of variables for the m-th material; and 1≤m≤M, wherein M stands a total number of materials in the first group.

In some embodiments, the computer-readable instructions are executable by a processor to cause the processor to further perform, identifying a second group of one or more materials from the plurality of materials, a respective material in the second group is a non-replaceable material with respect to at least one of the one or more product; comparing a respective theoretical consumption of the respective material in the second group in the period with a respective inventory amount of the respective material in the second group; and determining that whether the respective material in the second group is overstocked in the period.

In some embodiments, the computer-readable instructions are executable by a processor to cause the processor to further perform, upon determination that the respective theoretical consumption of the respective material in the second group in the period is equal to or greater than the respective inventory amount of the respective material in the second group, comprising determining that the respective material in the second group is not overstocked in the period.

In some embodiments, the computer-readable instructions are executable by a processor to cause the processor to further perform, upon determination that the respective theoretical consumption of the respective material in the second group in the period is less than the respective inventory amount of the respective material in the second group, determining whether the respective material in the second group is a replaceable material with respect to another product of the one or more products.

In some embodiments, the computer-readable instructions are executable by a processor to cause the processor to further perform, upon determination that the respective material in the second group is not a replaceable material with respect to any product of the one or more products, determining that the respective material in the second group is overstocked in the period.

In some embodiments, the computer-readable instructions are executable by a processor to cause the processor to further perform, upon determination that the respective material in the second group is a replaceable material with respect to the another product, calculating a maximum consumption of the replaceable material in the period using a linear programming model with respect to the another; and comparing the maximum consumption of the replaceable material in the period with an available inventory amount of the replaceable material, and determining whether the replaceable material is overstocked in the period. Optionally, the available inventory amount of the replaceable material is equal to the respective inventory amount subtracted by the respective theoretical consumption of the replaceable material in the period.

In some embodiments, the computer-readable instructions are executable by a processor to cause the processor to further perform, calculating the respective theoretical consumption of the respective material in the second group in the period. Optionally, the respective theoretical consumption of the respective material in the second group in the period is equal to a sum of values of one or more demands in the period for one or more products requiring the respective material in the second group as a non-replaceable material respectively multiplied by respective unit consumptions of the respective material in the second group with respect to the one or more products.

In some embodiments, the computer-readable instructions are executable by a processor to cause the processor to further perform, extracting data on materials in the first group from the data on the plurality of materials for making one or more products; and updating the data on materials in the first group upon determination an individual material in the first group is also a non-replaceable material with respect to another product of the one or more products.

In some embodiments, an available inventory amount of the individual material for the purpose of calculating a maximum consumption thereof is updated as being equal to an actual inventory amount of the individual material subtracted by a respective theoretical consumption in the period of the individual material as the non-replaceable material with respect to the another product.

In some embodiments, the computer-readable instructions are executable by a processor to cause the processor to further perform, upon determining the respective material in the first group or the respective material in the second group is overstocked in the period, determining an overstock status for the respective material in the first group or the respective material in the second group that is overstocked in the period. In some embodiments, the overstock status is one of a first status, a second status, a third status, or a fourth status. Optionally, in the first status, a demand for an overstocked material is zero in an entirety of the period. Optionally, the period comprises a first sub-period followed by a second sub-period. Optionally, in the second status, the demand for the overstocked material is zero in the second sub-period, and is non-zero in the first sub-period. Optionally, in the third status, the demand for the overstocked material is zero in the first sub-period, and is non-zero in the second sub-period. Optionally, in the fourth status, the demand for the overstocked material is non-zero in the first sub-period, and is non-zero in the second sub-period.

In some embodiments, the computer-readable instructions are executable by a processor to cause the processor to further perform, upon determining the respective material in the first group or the respective material in the second group is overstocked in the period, determining one or more underlying reasons for material overstock; and adjust one or more production parameters in the period for the one or more products to minimize the material overstock.

In some embodiments, the data comprises data on priority level of the one or more materials in the first group. Optionally, a higher priority level for a material in the first group indicates the material is more preferred in producing a corresponding product over one having a lower priority level.

In some embodiments, the computer-readable instructions are executable by a processor to cause the processor to further perform, upon determination the respective material in the first group is overstocked in the period, adjusting the priority level of the respective material in the first group; and producing the one or more products based on adjusted priority level of the one or more materials in the first group.

In some embodiments, the computer-readable instructions are executable by a processor to cause the processor to further perform, upon determining the respective material in the first group or the respective material in the second group is overstocked in the period, adjusting a demand in the period for the one or more products to minimize material overstock; and producing the one or more products based on adjusted demand in the period for the one or more products.

In some embodiments, the computer-readable instructions are executable by a processor to cause the processor to further perform generating one or more user interfaces. In some embodiments, the one or more user interfaces includes a first output interface configured to display an overstock status for the respective material in the first group or the respective material in the second group that is overstocked in the period. The overstock status indicates the reason or reasons for overstocking. In some embodiments, the first output interface is configured to display an identification number for an overstocked material in the period, and the overstock status associated with the overstocked material. In some embodiments, the overstock status is selected from a group consisting of a first status, a second status, a third status, and a fourth status. The first status indicates that a demand for an overstocked material is zero in an entirety of the period. The second status indicates that a demand for an overstocked material is zero in a second sub-period in the period, and is non-zero in a first sub-period in the period, wherein the first sub-period is followed by the second sub-period. The third status indicates that a demand for an overstocked material is zero in a first sub-period in the period, and is non-zero in a second sub-period in the period, wherein the first sub-period is followed by the second sub-period. The fourth status indicates that a demand for an overstocked material is non-zero in a first sub-period in the period, and is non-zero in a second sub-period in the period, wherein the first sub-period is followed by the second sub-period.

In some embodiments, the first output interface is further configured to display at least one of an identification number for a manufacturing site having the overstocked material or a classification of the overstocked material.

In some embodiments, the one or more user interfaces further includes a first input interface configured to receive one or more user inputs for querying a database. In some embodiments, the computer-readable instructions are executable by a processor to cause the processor to further perform receiving, from the first input interface, a user selection of one or more conditions for selecting an overstocked material associated with the one or more conditions; in response to the user selection, and querying the database to determine one or more overstocked materials in the database associated with the one or more conditions. The one or more conditions in some embodiments include an overstock status as discussed above. Optionally, the one or more conditions further include at least one of an identification number for a manufacturing site, an identification number for a material, or a range of dates.

In some embodiments, the one or more user interfaces further includes a second output interface configured to display the one or more overstocked materials as a result of the querying the database. Optionally, the second output interface is further configured to display an identification number for one or more products produced by the one or more overstocked materials. Optionally, the second output interface is further configured to display a demand for an overstocked material for making a respective product, e.g., in a most recent period (including a first sub-period and a second sub-period). The user can analyze the relationship between the demand and the overstock status.

In some embodiments, the one or more user interfaces further includes a second input interface configured to receive one or more user inputs for adjusting the priority level of the respective material in the first group. Based on an adjusted priority level of the respective material in the first group, the computer-readable instructions are executable by a processor to cause the processor to further perform re-determining the respective material in the first group is overstocked in the period. By adjusting the priority level of the respective material (e.g., the overstocked material) in the first group, inventory costs and material overstock can be lowered.

In some embodiments, the one or more user interfaces further includes a third input interface configured to receive one or more user inputs for adjusting the demand in the period for the one or more products. Based on an adjusted demand in the period for the one or more products, the computer-readable instructions are executable by a processor to cause the processor to further perform calculating an adjusted maximum consumption of the respective material in the first group in the period; comparing the adjusted maximum consumption of the respective material in the first group in the period with an available inventory amount of the respective material in the first group; and re-determining whether the respective material in the first group is overstocked in the period. By adjusting the demand in the period for the one or more products, the material overstock may be lowered, the manufacturer can better cater to the market, and the products may be made available faster.

In some embodiments, the one or more user interfaces further includes a third output interface configured to display an estimated surplus amount with respect to an overstock material at a first manufacturing site and an estimated deficit amount with respect the overstock material at a second manufacturing site. Optionally, the third output interface is configured to display a table comprising an identification number of the overstocked material, identification numbers of the manufacturing sites, the estimated surplus amount, and the estimated deficit amount. In some embodiments, the user may allocate the overstock material between manufacturing sites based on several factors including transportation cost, how urgent the overstock material is needed in the second manufacturing site, and so on.

Various illustrative operations described in connection with the configurations disclosed herein may be implemented as electronic hardware, computer software, or combinations of both. Such operations may be implemented or performed with a general purpose processor, a digital signal processor (DSP), an ASIC or ASSP, an FPGA or other programmable logic device, discrete gate or transistor logic, discrete hardware components, or any combination thereof designed to produce the configuration as disclosed herein. For example, such a configuration may be implemented at least in part as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a general purpose processor or other digital signal processing unit. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A software module may reside in a non-transitory storage medium such as RAM (random-access memory), ROM (read-only memory), nonvolatile RAM (NVRAM) such as flash RAM, erasable programmable ROM (EPROM), electrically erasable programmable ROM (EEPROM), registers, hard disk, a removable disk, or a CD-ROM; or in any other form of storage medium known in the art. An illustrative storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A computer-implemented method, comprising:
obtaining data on a plurality of materials for making one or more products;
identifying a first group of one or more materials from the plurality of materials, a respective material in the first group is a replaceable material with respect to at least one of the one or more product;
calculating a maximum consumption of the respective material in the first group in a period using a linear programming model with respect to the at least one of the one or more product;
comparing the maximum consumption of the respective material in the first group in the period with an available inventory amount of the respective material in the first group; and
determining whether the respective material in the first group is overstocked in the period.

2. The computer-implemented method of claim 1, wherein an objective function for the linear programming model is expressed as:
$$obj = max {\sum }_{i = 1}^{N} {d}_{i} * {x}_{i} ;$$
wherein xᵢ stands for an amount of a respective product that can be produced in the period using the respective material in the first group;
dᵢ stands for a unit consumption of the respective material in the first group with respect to the respective product; and
N is a positive integer, N≥1.

3. The computer-implemented method of claim 2, wherein the objective function is subject to a first constraint expressed as:
Σₓ_{ᵢ}_{∈(Q}_{ₗ}_{,G}_{ⱼ}₎xᵢ≤Qₗ;
wherein Qₗ stands for a demand for the respective product in the period;
(Qₗ, Qⱼ) stands for a set of variables for a j-th group of materials that are substitutable for each other in producing the respective product;
0≤xᵢ≤Qₗ; and
1≤j≤J, wherein J stands for a total number of groups of materials that are substitutable for each other.

4. The computer-implemented method of claim 2, wherein the objective function is subject to a second constraint expressed as:
Σₓ_{ᵢ}_{∈x}_{ₘ}dᵢ*xᵢ≤Cₘ;
wherein Cₘ stands for an available inventory amount of a m-th material in the first group;
Xₘ stands for a set of variables for the m-th material; and
1≤m≤M, wherein M stands a total number of materials in the first group.

5. The computer-implemented method of claim 1, further comprising
identifying a second group of one or more materials from the plurality of materials, a respective material in the second group is a non-replaceable material with respect to at least one of the one or more product;
comparing a respective theoretical consumption of the respective material in the second group in the period with a respective inventory amount of the respective material in the second group; and
determining that whether the respective material in the second group is overstocked in the period.

6. The computer-implemented method of claim 5, upon determination that the respective theoretical consumption of the respective material in the second group in the period is equal to or greater than the respective inventory amount of the respective material in the second group, comprising determining that the respective material in the second group is not overstocked in the period.

7. The computer-implemented method of claim 5, upon determination that the respective theoretical consumption of the respective material in the second group in the period is less than the respective inventory amount of the respective material in the second group, further comprising:
determining whether the respective material in the second group is a replaceable material with respect to another product of the one or more products.

8. The computer-implemented method of claim 7, upon determination that the respective material in the second group is not a replaceable material with respect to any product of the one or more products, further comprising determining that the respective material in the second group is overstocked in the period.

9. The computer-implemented method of claim 7, upon determination that the respective material in the second group is a replaceable material with respect to the another product, further comprising:
calculating a maximum consumption of the replaceable material in the period using a linear programming model with respect to the another product;
comparing the maximum consumption of the replaceable material in the period with an available inventory amount of the replaceable material; and
determining whether the replaceable material is overstocked in the period;
wherein the available inventory amount of the replaceable material is equal to the respective inventory amount subtracted by the respective theoretical consumption of the replaceable material in the period.

10. The computer-implemented method of claim 5, further comprising calculating the respective theoretical consumption of the respective material in the second group in the period;
wherein the respective theoretical consumption of the respective material in the second group in the period is equal to a sum of values of one or more demands in the period for one or more products requiring the respective material in the second group as a non-replaceable material respectively multiplied by respective unit consumptions of the respective material in the second group with respect to the one or more products.

11. The computer-implemented method of claim 5, comprising a plurality of first steps and a plurality of second steps;
wherein at least one first step of the plurality of first steps is performed prior to performing at least one second step of the plurality of second steps;
wherein the plurality of first steps comprise at least one of:
identifying the second group of one or more materials from the plurality of materials;
comparing the respective theoretical consumption of the respective material in the second group in the period with the respective inventory amount of the respective material in the second group; or
determining that whether the respective material in the second group is overstocked in the period;
wherein the plurality of second steps comprise at least one of:
identifying the first group of one or more materials from the plurality of materials;
calculating the maximum consumption of the respective material in the first group in the period using the linear programming model with respect to the at least one of the one or more product;
comparing the maximum consumption of the respective material in the first group in the period with the available inventory amount of the respective material in the first group; or
determining whether the respective material in the first group is overstocked in the period.

12. The computer-implemented method of claim 1, further comprising:
extracting data on materials in the first group from the data on the plurality of materials for making one or more products; and
updating the data on materials in the first group upon determination an individual material in the first group is also a non-replaceable material with respect to another product of the one or more products.

13. The computer-implemented method of claim 12, wherein an available inventory amount of the individual material for the purpose of calculating a maximum consumption thereof is updated as being equal to an actual inventory amount of the individual material subtracted by a respective theoretical consumption in the period of the individual material as the non-replaceable material with respect to the another product.

14. The computer-implemented method of claim 1, upon determination the respective material in the first group or the respective material in the second group is overstocked in the period, further comprising determining an overstock status for the respective material in the first group or the respective material in the second group that is overstocked in the period;
wherein the overstock status is one of a first status, a second status, a third status, or a fourth status;
wherein, in the first status, a demand for an overstocked material is zero in an entirety of the period;
the period comprises a first sub-period followed by a second sub-period;
in the second status, the demand for the overstocked material is zero in the second sub-period, and is non-zero in the first sub-period;
in the third status, the demand for the overstocked material is zero in the first sub-period, and is non-zero in the second sub-period; and
in the fourth status, the demand for the overstocked material is non-zero in the first sub-period, and is non-zero in the second sub-period.

15. The computer-implemented method of claim 1, upon determination the respective material in the first group or the respective material in the second group is overstocked in the period, further comprising:
determining one or more underlying reasons for material overstock; and
adjusting one or more production parameters in the period for the one or more products to minimize the material overstock.

16. The computer-implemented method of claim 1, wherein the data comprises data on priority level of the one or more materials in the first group;
a higher priority level for a material in the first group indicates the material is more preferred in producing a corresponding product over one having a lower priority level.

17. The computer-implemented method of claim 16, upon determination the respective material in the first group is overstocked in the period, further comprising:
adjusting the priority level of the respective material in the first group; and
producing the one or more products based on adjusted priority level of the one or more materials in the first group.

18. The computer-implemented method of claim 1, upon determination the respective material in the first group or the respective material in the second group is overstocked in the period, further comprising:
adjusting a demand in the period for the one or more products to minimize material overstock; and
producing the one or more products based on adjusted demand in the period for the one or more products.

19. (canceled)

20. (canceled)

21. (canceled)

22. (canceled)

23. (canceled)

24. (canceled)

25. An apparatus for managing production of one or more products, comprising:
a memory;
one or more processors;
wherein the memory and the one or more processors are connected with each other; and
the memory stores computer-executable instructions for controlling the one or more processors to:
obtain data on a plurality of materials for making one or more products;
identify a first group of one or more materials from the plurality of materials, a respective material in the first group is a replaceable material with respect to at least one of the one or more product;
calculate a maximum consumption of the respective material in the first group in a period using a linear programming model with respect to the at least one of the one or more product;
compare the maximum consumption of the respective material in the first group in the period with an available inventory amount of the respective material in the first group; and
determine whether the respective material in the first group is overstocked in the period.

26. A computer-program product, comprising a non-transitory tangible computer-readable medium having computer-readable instructions thereon, the computer-readable instructions being executable by a processor to cause the processor to perform:
obtaining data on a plurality of materials for making one or more products;
identifying a first group of one or more materials from the plurality of materials, a respective material in the first group is a replaceable material with respect to at least one of the one or more product;
calculating a maximum consumption of the respective material in the first group in a period using a linear programming model with respect to the at least one of the one or more product;
comparing the maximum consumption of the respective material in the first group in the period with an available inventory amount of the respective material in the first group; and
determining whether the respective material in the first group is overstocked in the period.
